(19) United States
(12) Patent Application Publication
(10) Pub. No.: US 2006/0210787 A1
(43) Pub. Date: Sep. 21, 2006

(54) Structure stuffed with melamine and polyurethane foam

(76) Inventor: Alberto Veneruso, Cittadinanza (IT)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/375,901

(22) Filed: Mar. 15, 2006

(30) Foreign Application Priority Data
Mar. 18, 2005 (IT) RM2005A000126

(51) Int. Cl. B32B 7/12; B32B 3/26; B32B 3/00

(52) U.S. Cl. 428/304.4; 428/313.3; 428/317.1

(57) ABSTRACT

The invention relates to a stuffed structure comprising a core and a coating wherein the core comprises melamine and the coating comprises polyurethane foam comprising, for 100 parts by weight of a polyol, between 15 and 30 parts by weight of graphite, between 4 and 10 parts by weight of hollow charges of a glass material, and between 50 and 70 parts by weight of isocyanate.

This application claims priority under 35 U.S.C. § 119(a) to Italian Patent Application No. RM2005A000126, filed Mar. 18, 2005. The foregoing application is incorporated by reference herein.

### FIELD OF THE INVENTION

The present invention relates to structures stuffed with melamine and polyurethane foam. More specifically, the invention relates to a stuffed structure which can be made as a very light structure without jeopardizing its other properties, such as, mechanical strength, density, and fire behavior. The present invention is particularly suitable for the aeronautic field, however, it is applicable to any other field.

### BACKGROUND OF THE INVENTION

For many years, solutions have been sought in the aeronautic field for creating stuffed structures for seats which satisfy the limiting requirements of aeronautic tests. In particular, stuffed structures which are sufficiently comfortable have been sought which are made as light as possible.

Specifically, it would be desirable to create polyurethane foams suitable for molding cushions which satisfy aeronautic requirements. Preferably, the polyurethane foam would have the following features:
fire behavior: passing the Oil Burner Test (ref: Federal Aviation Regulations (FAR) 25, Appendix F, Part III); and
density: <=60 Kg/m³.

Recently, cushions have been generated which comprise polyurethane foam with the addition of graphite in order to tar the compound and confer to the polyurethane foam anti-flame properties that the polyurethane foam does not have. Examples of this kind are described in European Patents EP 0414868 and EP 0450403, both in the name of Metzeler Schaum GmbH. A process is described in both patents for manufacturing a polyurethane foam which is flexible, elastic, has anti-flame properties wherein a polyol and a polyisocyanate are mixed with graphite.

The introduction of a particular kind of graphite in the reaction mixture, as suggested in the above patents, produced a polyurethane foam with good physical and mechanical properties and capable of passing the Oil Burner Test. However, these polyurethane foams have drawbacks. In particular, the density of the foamed piece obtained by the above mixture had to be at least 70 Kg/m³ in order to pass the Oil Burner Test. This density is too high for aeronautic cushions and is a serious limit to the commercialization of these cushions.

More recently, melamine has been used for synthesizing stuffed structures. This concept is described in the International Patent Application WO 03/072391, filed in the name of J.S.O. Melamine has been used in synthesizing stuffed structures in fields other than the aeronautic field. It requires that the structure be coated in order to make the structure comfortable enough for a passenger.

In view of the above, there is a clear need to obviate the above described drawback. Specifically, methods for producing structures stuffed with a polyurethane foam that satisfies the Oil Burner Test requirements and, at the same time, is comfortable and allows for the formation of a structure with a much lower density with respect to the previously produced structures comprising polyurethane foam.

### SUMMARY OF THE INVENTION

Superior stuffed structures are obtained according to the present invention by coating a core comprised of melamine foam with a polyurethane foam generated from a reaction mixture comprising a very light component, particularly hollow glass microspheres, the low density of which (about 150 Kg/m³) contributes to raise the volume of the liquid mixture before expansion.

According to one aspect of the instant application, the stuffed structure comprises a core and a coating. An exemplary core comprises melamine foam and n exemplary coating comprises a polyurethane foam comprising, for 100 parts in weight of a polyol, between 15 and 30 parts in weight of graphite, between 4 and 10 parts in weight of hollow charges of a glass material, and between 50 and 70 parts in weight of isocyanate.

In a preferred embodiment, the polyurethane foam comprises between 18 and 25 parts in weight of graphite and more preferably comprises 20 parts in weight of graphite.

In a particular embodiment of the invention, the graphite is an expandable graphite.

In yet another embodiment of the invention, the polyurethane foam comprises between 6 and 8 parts in weight of hollow charges of glass material, more preferably the polyurethane foam comprises 7 parts in weight of hollow charges of glass material.

In a particular embodiment of the invention, the isocyanate is modified diphenylmethane 4,4′ diisocyanate.

In still another embodiment, the hollow structures of glass material are hollow glass microspheres.

According to one aspect of the instant invention, the hollow charges of glass material can be mixed with polyol, with isocyanate or with both of them during the production of the polyurethane foam.

According to yet another aspect of the invention, triethyl phosphate can be added, particularly in an amount of 1 to 5 parts in weight, preferably 2 to 4 parts in weight, and still more preferably 3 parts in weight, with respect to 100 parts of polyol.

In a preferred embodiment, the core and coating are coupled by an adhesive, in particular a water based adhesive.

The instant invention further relates to a stuffed structure employing a polyurethane foam as described in the above.

### BRIEF DESCRIPTION OF THE DRAWINGS

FIG. 1 is a lateral view of a stuffed structure according to the instant invention.

FIG. 2 is a top view of a stuffed structure according to the instant invention.

FIG. 3 is a sectional view of the stuffed structure of FIG. 1. 1 is a stuffed structure of the instant invention. 2 is a melamine resin inner core. 3 is a polyurethane outer coating.

### DETAILED DESCRIPTION OF THE INVENTION

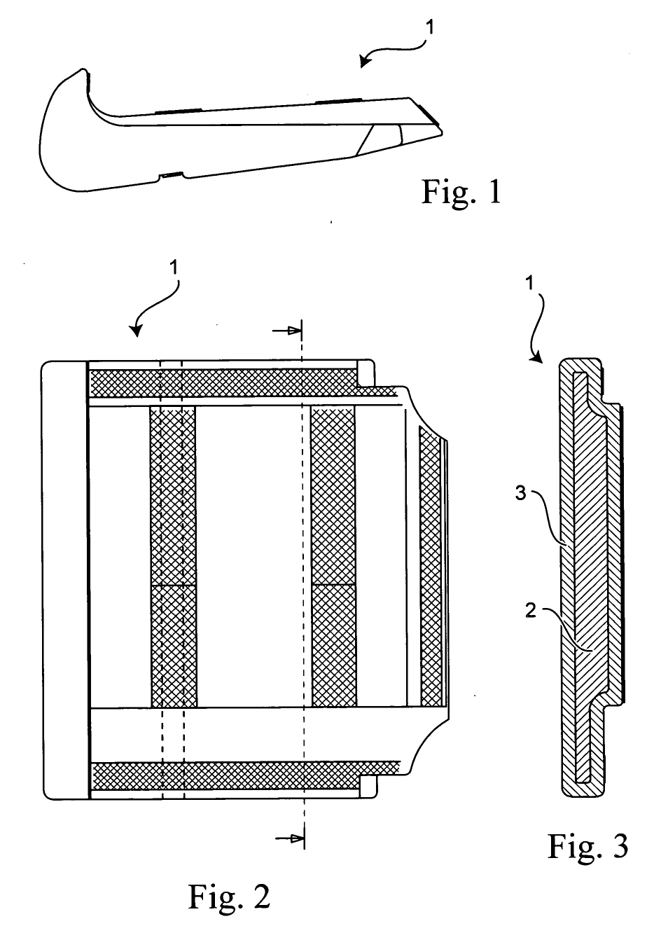

FIGS. 1-3 provide a generic stuffed structure of the instant invention indicated by reference number 1, wherein the melamine resin inner core is indicated by reference number 2 and a polyurethane foam outer coating is indicated by reference number 3.

In a particular embodiment, the melamine resin can be Basotec® resin from BASF.

As already described, different possible combinations of components can be employed to synthesize the melamine and polyurethane foams and stuffed structures of the invention.

The physical and chemical features of the components and the weight composition of the reaction mixture are provided hereinbelow for illustrative, but not limitative purposes.

It has already been mentioned hereinabove that isocyanate does not need to be present in the polyurethane foams and that it is possible to synthesize the foams employing only polyol. The amount of isocyanate employed is variable (also in composition C) as the softness of the synthesized polyurethane foam is determined by the amount of isocyanate (i.e., the higher is the amount of isocyanate, the harder is the cushion obtained; the lower is the amount of isocyanate, the softer is the cushion obtained).

When providing percentages and composition of the polyurethane compound, 100 parts in weight of polyol is used as a standard to which the amount of the other components are referred. Obviously, if the percentage composition is desired, the polyol proportion can be varied accordingly.

Formulas 1 and 2, provided hereinbelow in Table 2, take into consideration only the main components (polyol, isocyanate, graphite and microspheres). In Formula 1, the solid parts (graphite and microspheres) are all dispersed within polyol. In Formula 2, the solid parts are dispersed both in component “a” (polyol) and in component “b” (isocyanate).

A fifth component is introduced in Formula 3: triethyl phosphate (TEP). TEP is a low viscosity anti-flame liquid which affords two advantages:
easy workability of the mixture; and
ability to pass the Oil Burner Test.

In a particular embodiment, diphenyl methane 4,4′ diisocyanate (MDI) having the features set forth in Table 1 are employed.

TABLE 1

| | | | |
|---|---|---|---|
| % NCO | 20-30 | 22-28 | 27 |
| functionality | 2-3 | 2.2-2.7 | 2.3 |

Expandable graphite may be employed as the graphite. Additionally, the very light component of the reaction material may be microspheres comprised of fine grain inert mineral powders, such as hollow glass microspheres.

TABLE 2

| | FORMULA 1 | | | FORMULA 2 | | | FORMULA 3 | | |
|---|---|---|---|---|---|---|---|---|---|
| | A | B | C | A | B | C | A | B | C |
| Comp “a” | | | | | | | | | |
| polyol | 100 | 100 | 100 | 100 | 100 | 100 | 100 | 100 | 100 |
| graphite | 15-30 | 18-25 | 20 | 15-30 | 18-25 | 20 | 15-30 | 18-25 | 22 |
| Microspheres | 4-10 | 6-8 | 7 | — | — | — | | | |
| TEP | — | — | — | — | — | — | 1-5 | 2-4 | 3 |
| Comp “b” | | | | | | | | | |
| isocyanate | 50-70 | 50-70 | 50-70 | 50-70 | 50-70 | 50-70 | 50-70 | 50-70 | 50-70 |
| microspheres | — | — | — | 6-12 | 8-10 | 9 | 6-12 | 8-10 | 9 |

The present invention has been described for illustrative but not limitative purposes, according to its preferred embodiments, but it is to be understood that modifications and/or changes can be introduced by those skilled in the art without departing from the relevant scope as defined in the enclosed claims.

Patent documents and applications are cited in the foregoing specification in order to describe the state of the art to which this invention pertains. The entire disclosure of these citations is incorporated by reference herein.

What is claimed is:

1. A stuffed structure comprising a core and a coating, wherein said core comprises melamine foam and wherein said coating comprises a polyurethane foam comprising, for 100 parts by weight of a polyol, between 15 and 30 parts by weight of graphite, between 4 and 10 parts by weight of hollow charges of a glass material, and between 50 and 70 parts by weight of isocyanate.

2. A stuffed structure according to claim 1, wherein said graphite is between 18 and 25 parts by weight.

3. A stuffed structure according to claim 2, wherein said graphite is 20 parts by weight.

4. A stuffed structure according to claim 1, wherein said graphite is expandable graphite.

5. A stuffed structure according to claim 1, wherein said hollow charges of glass material are between 6 and 8 parts by weight.

6. A stuffed structure according to claim 5, wherein said hollow charges of glass material are 7 parts by weight.

7. A stuffed structure according to claim 1, wherein said isocyanate is modified diphenyl methane 4,4′ diisocyanate.

8. A stuffed structure according to claim 1, wherein said hollow charges of glass material are hollow glass microspheres.

9. A stuffed structure according to claim 1, wherein said hollow charges of glass material are mixed with polyol, isocyanate or both during the synthesis of said polyurethane foam.

10. A stuffed structure according to claim 1, wherein said polyurethane foam further comprises between 1 and 5 parts by weight of triethylphosphate.

11. A stuffed structure according to claim 10, wherein said triethylphosphate is between 2 and 4 parts by weight.

12. A stuffed structure according to claim 10, wherein said triethylphosphate is 3 parts by weight.

13. A stuffed structure according to claim 1, wherein said core and coating are coupled by an adhesive.

14. A stuffed structure according to claim 13, wherein said adhesive is a water based adhesive.
